(19) United States
(12) Patent Application Publication
(10) Pub. No.: US 2008/0233433 A1
(43) Pub. Date: Sep. 25, 2008

(54) ORGANIC ELECTROLUMINESCENT DEVICE

(75) Inventors: Tatsuya IGARASHI, Tokyo (JP); Hisashi OKADA, Kanagawa (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/051,895

(22) Filed: Mar. 20, 2008

(30) Foreign Application Priority Data
Mar. 23, 2007 (JP) 2007-077414

(51) Int. Cl. H01J 1/63

(52) U.S. Cl. 428/704

(57) ABSTRACT

An organic electroluminescent device is provided and includes: a pair of electrodes; and at least one organic layer between the pair of electrodes, the at least one organic layer including a light-emitting layer. At least one of the at least one organic layers contains an iridium complex having a 5-membered heterocyclic structure consisting of a carbon atom and a nitrogen atom, and a deuterium atom on an SP2 carbon atom in the iridium complex.

### BACKGROUND OF THE INVENTION

1. Field of the Invention

The present invention relates to a light-emitting device, particularly an organic electroluminescent device (hereinafter also referred to as “light-emitting device” or “EL device”), capable of emitting light by converting electric energy into light.

2. Background Art

Organic electroluminescent devices are attracting public attention as promising display devices for capable of emitting light of high luminance with low voltage. An important characteristic of organic electroluminescent devices is consumed electric power. Consumed electric power is equal to the product of the voltage and the electric current, and the lower the value of voltage that is necessary to obtain desired brightness and the smaller the value of electric current, the lower is the consumed electric power of the device.

As one attempt to lower the value of electric current that flows to a device, a light-emitting device utilizing luminescence from ortho-metalated iridium complex (Ir(Ppy)₃: Tris-Ortho-Metalated Complex of Iridium(III) with 2-Phenylpyridine) is reported (see Applied Physics Letters 75, 4 (1999), JP-A-2001-247859 and JP-T-2004-515506). The phosphorescent devices disclosed therein are greatly improved in external quantum efficiency as compared with singlet luminescent devices in the related art, and have succeeded in making the value of electric current smaller.

For the purpose of the improvement of the efficiency, durability and luminescent colors (shortening of luminescent wavelength) of phosphorescent devices, a device containing an iridium complex having a 5-membered heterocyclic structure such as pyrazole is reported (see WO 2006/121811), but further improvement is required in the point of durability.

Trials to introduce deuterium atoms to these iridium complexes are examined, but data concerning the improvement of durability are not obtained. For example, the data of durability of devices in which a deuterium atom is introduced to an alkyl group are reported in WO 2006/121811, but improving effect of durability by the introduction of a deuterium atom is not obtained yet (device A and device H).

### SUMMARY OF THE INVENTION

An object of an illustrative, non-limiting embodiment of the present invention is to provide a light-emitting device excellent in durability.

The above object can be achieved by the following exemplary embodiments.

(1) An organic electroluminescent device including:

a pair of electrodes; and

at least one organic layer between the pair of electrodes, the at least one organic layer including a light-emitting layer,

wherein at least one of the at least one organic layers contains an iridium complex having a 5-membered heterocyclic structure consisting of a carbon atom and a nitrogen atom, and a deuterium atom on an SP2 carbon atom in the iridium complex.

(2) The organic electroluminescent according to item (1) above, wherein the 5-membered heterocyclic structure is a 5-membered heterocyclic structure including two nitrogen atoms.
(3) The organic electroluminescent according to item (1) or (2) above, wherein the iridium complex is a compound represented by formula (1):

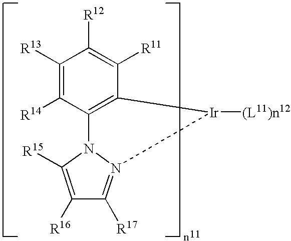

wherein R¹¹ to R¹⁷ each independently represents a hydrogen atom or a substituent, at least one of R¹¹ to R¹⁷ is a deuterium atom; L¹¹ represents a ligand and; n¹¹ represents an integer of from 1 to 3 and n¹² represents an integer of from 0 to 4, provided that n¹¹ and n¹² represent integers so that the coordination number of Ir is 6.
(4) The organic electroluminescent device according to item (1) or (2) above, wherein the iridium complex is a compound represented by formula (2):

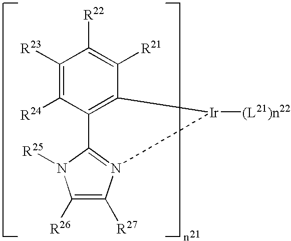

wherein R²¹ to R²⁷ each independently represents a hydrogen atom or a substituent, at least one of R²¹ to R²⁴, R²⁶ and R²⁷ is a deuterium atom; L²¹ represents a ligand and; n²¹ represents an integer of from 1 to 3 and n²² represents an integer of from 0 to 4, provided that n²¹ and n²² represent integers so that the coordination number of Ir is 6.
(5) The organic electroluminescent device according to item (1) or (2) above, wherein the iridium complex is a compound represented by formula (3):

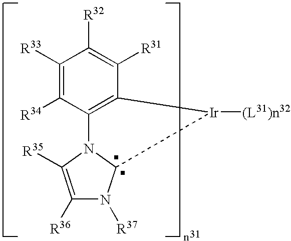

wherein R³¹ to R³⁷ each independently represents a hydrogen atom or a substituent, at least one of R³¹ to R³⁶ is a deuterium atom; L³¹ represents a ligand and; n³¹ represents an integer of from 1 to 3 and n³² represents an integer of from 0 to 4, provided that n³¹ and n³² represent integers so that the coordination number of Ir is 6.
(6) The organic electroluminescent device according to any one of items (1) to (5) above, wherein the light-emitting layer contains pyrrole as a host material.
(7) The organic electroluminescent device according to any one of items (1) to (6) above, satisfying a relationship: 0≦the number of hydrogen atoms on the SP2 carbon atom/the number of deuterium atoms on the SP2 carbon atom≦1.
(8) The organic electroluminescent device according to any one of items (1) to (7) above, wherein the light-emitting layer contains a host material having a minimum triplet excitation state, and an energy level T₁ in the minimum triplet excitation state is from 60 kcal/mol (251.4 kJ/mol) to 90 kcal/mol (377.1 kJ/mol).

### DETAILED DESCRIPTION OF THE EXEMPLARY EMBODIMENTS

A light-emitting device according to an exemplary embodiment of the invention can emit light in high luminance efficiency, and is small in lowering of luminance and rising of driving voltage when the device is driven for a long time and is excellent in durability.

According to an exemplary embodiment of the invention, an organic electroluminescent device includes a pair of electrodes and at least one organic layer between the pair of electrodes, the at least one organic layer containing a light-emitting layer. At least one of the at least one organic layer contains an iridium complex having at least one 5-membered heterocyclic structure consisting of a carbon atom and a nitrogen atom, and at least one deuterium atom on an SP2 carbon atom of the iridium complex.

In the specification, “SP2 carbon atom” means a carbon atom involved in a carbon-carbon double bond or a carbon-hetero atom double bond.

An iridium complex in the invention is contained in at least one layer of the later-described organic light-emitting layer, hole transporting layer, electron transporting layer, charge blocking layer, hole injecting layer, and electron injecting layer, and is preferably contained in at least an organic light-emitting layer.

The iridium complex having at least one 5-membered heterocyclic structure consisting of a carbon atom and a nitrogen atom, and at least one deuterium atom on an SP2 carbon atom is described below. The number of nitrogen atoms in the 5-membered heterocyclic structure consisting of a carbon atom and a nitrogen atom is preferably from 1 to 3, more preferably 1 or 2, and still more preferably 2, in view of luminance efficiency, prolonging of operational lifetime, and reduction of driving voltage.

As the 5-membered heterocyclic structure consisting of a carbon atom and a nitrogen atom, a pyrrole ring, a pyrazole ring, an imidazole ring, a triazole ring, and a ring having a carbene carbon put between two nitrogen atoms are preferred, a pyrazole ring, an imidazole ring, and a ring having a carbene carbon put between two nitrogen atoms are more preferred, a pyrazole ring and an imidazole ring are still more preferred, and a pyrazole ring is especially preferred, in view of luminance efficiency, prolonging of operational lifetime, and reduction of driving voltage.

The hydrogen atom on an SP2 carbon atom is not especially restricted, and a hydrogen atom on the vinyl position (a hydrogen atom of ethylene, etc.), a hydrogen atom on the aryl position (a hydrogen atom of benzene), and a hydrogen atom on the hetero aryl position (a hydrogen atom on the carbon atom in pyrazole, a hydrogen atom on the carbon atom in imidazole, and a hydrogen atom in pyridine) are exemplified. It is preferred to have a deuterium atom on the SP2 carbon atom of aryl, and to have a deuterium atom on the SP2 carbon atom of a 5-membered heterocyclic ring consisting of a carbon atom and a nitrogen atom, in view of prolonging of operational lifetime.

The number of deuterium atoms in the iridium complex is not especially restricted, but, in view of prolonging of operational lifetime, it is preferred that 0≦the number of hydrogen atoms on the SP2 carbon atom/the number of deuterium atoms on the SP2 carbon atom≦1, it is more preferred that 0≦the number of hydrogen atoms on the SP2 carbon atom/the number of deuterium atoms on the SP2 carbon atom≦0.5, it is still more preferred that 0≦the number of hydrogen atoms on the SP2 carbon atom/the number of deuterium atoms on the SP2 carbon atom≦0.2, and it is especially preferred that 0≦the number of hydrogen atoms on the SP2 carbon atom/the number of deuterium atoms on the SP2 carbon atom≦0.1.

An iridium complex in the invention is preferably a compound represented by formula (1), (2) or (3) in view of luminance efficiency, prolonging of operational lifetime, and reduction of driving voltage; more preferably a compound represented by formula (1) or (2) in view of prolonging of operational lifetime, and still more preferably a compound represented by formula (1). The compound represented by formula (1), (2) or (3) can be used alone or in combination. When a compound represented by specific formula is used alone, compounds having the same structure may be used, or compounds having different structures may be used in combination (this is applied to both compounds when compounds represented by specific formulae respectively are used in combination). Formulae (1), (2) and (3) are described below.

R¹¹ to R¹⁷ each represents a hydrogen atom or a substituent, and at least one of R¹¹ to R¹⁷ is a deuterium atom. The examples of the substituent include, in addition to a deuterium atom, an alkyl group (liner, branch or cyclic alkyl group preferably having from 1 to 30 carbon atoms, more preferably from 1 to 20 carbon atoms, and especially preferably from 1 to 10 carbon atoms, e.g., methyl, ethyl, iso-propyl, n-octyl, n-decyl, n-hexadecyl, cyclopropyl, cyclopentyl, cyclohexyl, etc., are exemplified), an alkenyl group (preferably having from 2 to 30 carbon atoms, more preferably from 2 to 20 carbon atoms, and especially preferably from 2 to 10 carbon atoms, e.g., vinyl, allyl, 2-butenyl, 3-pentenyl, etc., are exemplified), an alkynyl group (preferably having from 2 to 30 carbon atoms, more preferably from 2 to 20 carbon atoms, and especially preferably from 2 to 10 carbon atoms, e.g., propargyl, 3-pentynyl, etc., are exemplified), an aryl group (monocyclic or condensed aryl group preferably having from 6 to 30 carbon atoms, more preferably from 6 to 20 carbon atoms, and especially preferably from 6 to 14 carbon atoms, e.g., phenyl, naphthyl, fluorenyl, anthranyl, phenanthreny, naphthacenyl, benzo[a]anthracenyl, triphenylenyl, pyrenyl, crycenyl, perylenyl, etc., are exemplified. As an aryl group, a monocyclic ring or condensed ring of 5 rings are preferred, a monocyclic ring or a condensed ring of 3 rings are more preferred, phenyl, naphthyl, fluorenyl, anthranyl, phenanthrenyl are still more preferred, and phenyl, naphthyl, fluorenyl, anthranyl are especially preferred. The aryl group may be substituted with alkyl group (preferably having from 1 to 5 carbon atoms), aryl group (preferably having from 6 to 14 carbon atoms) or aromatic heterocyclic group (preferably having from 1 to 12 carbon atoms), an amino group (preferably having from 0 to 30 carbon atoms, more preferably from 0 to 20 carbon atoms, and especially preferably from 0 to 10 carbon atoms, e.g., amino, methylamino, dimethylamino, diethylamino, dibenzylamino, diphenylamino, ditolylamino, etc., are exemplified), an alkoxyl group (preferably having from 1 to 30 carbon atoms, more preferably from 1 to 20 carbon atoms, and especially preferably from 1 to 10 carbon atoms, e.g., methoxy, ethoxy, butoxy, 2-ethylhexyloxy, etc., are exemplified), an aryloxy group (preferably having from 6 to 30 carbon atoms, more preferably from 6 to 20 carbon atoms, and especially preferably from 6 to 12 carbon atoms, e.g., phenyloxy, 1-naphthyloxy, 2-naphthyloxy, etc., are exemplified), a heterocyclic oxy group (preferably having from 1 to 30 carbon atoms, more preferably from 1 to 20 carbon atoms, and especially preferably from 1 to 12 carbon atoms, e.g., pyridyloxy, pyrazyloxy, pyrimidyloxy, quinolyloxy, etc., are exemplified), an acyl group (preferably having from 2 to 30 carbon atoms, more preferably from 2 to 20 carbon atoms, and especially preferably from 2 to 12 carbon atoms, e.g., acetyl, benzoyl, formyl, pivaloyl, etc., are exemplified), an alkoxycarbonyl group (preferably having from 2 to 30 carbon atoms, more preferably from 2 to 20 carbon atoms, and especially preferably from 2 to 12 carbon atoms, e.g., methoxycarbonyl, ethoxycarbonyl, etc., are exemplified), an aryloxycarbonyl group (preferably having from 7 to 30 carbon atoms, more preferably from 7 to 20 carbon atoms, and especially preferably from 7 to 12 carbon atoms, e.g., phenyloxycarbonyl, etc., are exemplified), an acyloxy group (preferably having from 2 to 30 carbon atoms, more preferably from 2 to 20 carbon atoms, and especially preferably from 2 to 10 carbon atoms, e.g., acetoxy, benzoyloxy, etc., are exemplified), an acylamino group (preferably having from 2 to 30 carbon atoms, more preferably from 2 to 20 carbon atoms, and especially preferably from 2 to 10 carbon atoms, e.g., acetylamino, benzoylamino, etc., are exemplified), an alkoxycarbonylamino group (preferably having from 2 to 30 carbon atoms, more preferably from 2 to 20 carbon atoms, and especially preferably from 2 to 12 carbon atoms, e.g., methoxycarbonylamino, etc., are exemplified), an aryloxycarbonylamino group (preferably having from 7 to 30 carbon atoms, more preferably from 7 to 20 carbon atoms, and especially preferably from 7 to 12 carbon atoms, e.g., phenyloxycarbonylamino, etc., are exemplified), a sulfonylamino group (preferably having from 1 to 30 carbon atoms, more preferably from 1 to 20 carbon atoms, and especially preferably from 1 to 12 carbon atoms, e.g., methanesulfonylamino, benzenesulfonylamino, etc., are exemplified), a sulfamoyl group (preferably having from 0 to 30 carbon atoms, more preferably from 0 to 20 carbon atoms, and especially preferably from 0 to 12 carbon atoms, e.g., sulfamoyl, methylsulfamoyl, dimethylsulfamoyl, phenylsulfamoyl, etc., are exemplified), a carbamoyl group (preferably having from 1 to 30 carbon atoms, more preferably from 1 to 20 carbon atoms, and especially preferably from 1 to 12 carbon atoms, e.g., carbamoyl, methylcarbamoyl, diethylcarbamoyl, phenylcarbamoyl, etc., are exemplified), an alkylthio group (preferably having from 1 to 30 carbon atoms, more preferably from 1 to 20 carbon atoms, and especially preferably from 1 to 12 carbon atoms, e.g., methylthio, ethylthio, etc., are exemplified), an arylthio group (preferably having from 6 to 30 carbon atoms, more preferably from 6 to 20 carbon atoms, and especially preferably from 6 to 12 carbon atoms, e.g., phenylthio, etc., are exemplified), a heterocyclic thio group (preferably having from 1 to 30 carbon atoms, more preferably from 1 to 20 carbon atoms, and especially preferably from 1 to 12 carbon atoms, e.g., pyridylthio, 2-benzimizolylthio, 2-benzoxazolylthio, 2-benzothiazolylthio, etc., are exemplified), a sulfonyl group (preferably having from 1 to 30 carbon atoms, more preferably from 1 to 20 carbon atoms, and especially preferably from 1 to 12 carbon atoms, e.g., mesyl, tosyl, etc., are exemplified), a sulfinyl group (preferably having from 1 to 30 carbon atoms, more preferably from 1 to 20 carbon atoms, and especially preferably from 1 to 12 carbon atoms, e.g., methanesulfinyl, benzenesulfinyl, etc., are exemplified), a ureido group (preferably having from 1 to 30 carbon atoms, more preferably from 1 to 20 carbon atoms, and especially preferably from 1 to 12 carbon atoms, e.g., ureido, methylureido, phenylureido, etc., are exemplified), a phosphoric amido group (preferably having from 1 to 30 carbon atoms, more preferably from 1 to 20 carbon atoms, and especially preferably from 1 to 12 carbon atoms, e.g., diethylphosphoric amido, phenylphosphoric amido, etc., are exemplified), a hydroxy group, a mercapto group, a halogen atom (e.g., a fluorine atom, a chlorine atom, a bromine atom, an iodine atom), a cyano group, a sulfo group, a carboxyl group, a nitro group, a hydroxamic acid group, a sulfino group, a hydrazino group, an imino group, a heterocyclic group (preferably having from 1 to 30 carbon atoms, and more preferably from 1 to 12 carbon atoms, and as the hetero atoms, e.g., a nitrogen atom, an oxygen atom, a sulfur atom, a phosphorus atom are exemplified, preferably a nitrogen atom or a oxygen atom are exemplified; and examples of the heterocyclic group includes pyrrolyl, pyrazyl, imidazolyl, pyridyl, quinolyl, furyl, thienyl, pyrrolizyl, piperidyl, morpholino, benzofuryl, benzoxazolyl, benzimidazolyl, benzothiazolyl, carbazolyl, azacarbazolyl, azepinyl, etc., are exemplified; As the heterocyclic group, a 5- or 6-membered monocyclic or condensed ring are preferred, a 5- or 6-membered aromatic heterocyclic ring are more preferred, a 5- or 6-membered aromatic heterocyclic ring containing a nitrogen or oxygen atom, pyrrolyl, imidazolyl, pyridyl, pyrazyl, quinolyl, isoqunolyl, furyl, thienyl, indolyl, benzofuryl, benzoxazolyl, benzimidazolyl, benzothiazolyl, carbazolyl, azacarbazolyl, azepinyl are still more preferred, and pyridyl, quinolyl, indolyl, benzofuryl, benzoxazolyl, benzimidazolyl, benzothiazolyl, carbazolyl, azacarbazolyl, azepinyl are most preferred), a silyl group (preferably having from 3 to 40 carbon atoms, more preferably from 3 to 30 carbon atoms, and especially preferably from 3 to 24 carbon atoms, e.g., trimethylsilyl, triphenylsilyl, etc., are exemplified), a silyloxy group (preferably having from 3 to 40 carbon atoms, more preferably from 3 to 30 carbon atoms, and especially preferably from 3 to 24 carbon atoms, e.g., trimethylsilyloxy, triphenylsilyloxy, etc., are exemplified). These substituents may be further substituted.

R¹¹ preferably represents a hydrogen atom, a deuterium atom, an alkyl group or an aryl group, more preferably a hydrogen atom or a deuterium atom, and still more preferably a deuterium atom, in view of prolonging of operational lifetime.

R¹² preferably represents a hydrogen atom, a deuterium atom, a fluorine atom, a cyano group, an alkyl group, an aryl group, or a hetero aryl group (preferably a 5- or 6-membered hetero aryl group), more preferably a hydrogen atom, a deuterium atom, a cyano group, or an aryl group, still more preferably a hydrogen atom, a deuterium atom or an aryl group, and especially preferably an aryl group, in view of prolonging of operational lifetime.

R¹³ preferably represents a hydrogen atom, a deuterium atom, a cyano group, an alkyl group, an aryl group, or a hetero aryl group, more preferably a hydrogen atom, a deuterium atom, or a cyano group, still more preferably a hydrogen atom or a deuterium atom, and especially preferably a deuterium atom, in view of prolonging of operational lifetime.

R¹⁴ preferably represents a hydrogen atom, a deuterium atom, an alkyl group, or an aryl group, more preferably a hydrogen atom or a deuterium atom, and still more preferably a deuterium atom, in view of prolonging of operational lifetime.

R¹⁵ preferably represents a hydrogen atom, a deuterium atom, an alkyl group, or an aryl group, more preferably a hydrogen atom or a deuterium atom, and still more preferably a deuterium atom, in view of prolonging of operational lifetime.

R¹⁶ preferably represents a hydrogen atom, a deuterium atom, a cyano group, an alkyl group, an aryl group, or a hetero aryl group, more preferably a hydrogen atom, a deuterium atom, or an aryl group, still more preferably a hydrogen atom or a deuterium atom, and especially preferably a deuterium atom, in view of prolonging of operational lifetime.

R¹⁷ preferably represents a hydrogen atom, a deuterium atom, an alkyl group, or an aryl group, more preferably a hydrogen atom or a deuterium atom, and still more preferably a deuterium atom, in view of prolonging of operational lifetime.

It is supposed that the substituents as the preferred scope of R¹¹ to R¹⁷ are difficult to be decomposed from a hole state (radical cation state), an electron state (radical anion state) and/or an excited state, which are generated by charges in the light-emitting device, and thereby the operational lifetime is prolonged.

R¹¹ to R¹⁷ may be combined to each other to form a ring, if possible.

L¹¹ represents a ligand. As the ligands, for example, the ligands described in H. Yersin, Photochemistry and Photophysics of Coordination Compounds, Springer-Verlag (1987), and Akio Yamamoto, Yuki Kinzoku Kagaku—Kiso to Oyo—(Organometal Chemistry—Elements and Applications), Shokabo Publishing Co., Ltd. (1982) are exemplified. The preferred examples of ligands include organometal ligands (ligands to coordinate via a carbon atom), halogen ligands (e.g., a chlorine ligand, a fluorine ligand, etc.), nitrogen-containing heterocyclic ligands (e.g., a bipyridyl ligand, a phenanthroline ligand, a phenylpyridine ligand, a pyrazolylpyridine ligand, a benzimidazolylpyridine ligand, a picolinic acid ligand, a thienylpyridine ligand, a pyrazolylpyridine ligand, an imidazolylpyridine ligand, a triazolylpyridine ligand, a pyrazolylbenzoxazole ligand, and condensed ligands thereof (e.g., a phenylquinoline ligand, a benzothienylpyridine ligand, a biquinoline ligand, etc.)), diketone ligands (e.g., an acetylacetone ligand), nitrile ligands (e.g., an acetonitrile ligand, etc.), CO ligands, isonitrile ligands (e.g., a t-butylisonitrile ligand, etc.), carbene ligands (e.g., a diamino-substituted carbene ligand, etc.), phosphorus ligands (e.g., a phosphine derivative, a phosphite ester derivative, a phosphinine derivative, etc.), and carboxylic acid ligands (e.g., an acetic acid ligand, etc.), more preferred ligands are diketone ligands, and bidentate nitrogen-containing heterocyclic ligands, and still more preferred ligands are bidentate nitrogen-containing heterocyclic ligands to coordinate via a carbon atom and a nitrogen atom.

The reason for why the above ligands are preferred is supposed as below. That is, the stability constant of the complex is high to suppress the deactivation without radiation so as to improve the luminance quantum efficiency as well as to suppress the decomposition of the complex so as to prolong the operational lifetime and the storage lifetime. Further, when the strength of the ligand field is strong, it has an advantage on short wavelength light-emitting. In further view of this, carbene ligands, phosphorus ligands and bidenate nitrogen-containing heterocyclic ligands to coordinate via a carbon atom and a nitrogen atom are preferred.

n¹¹ represents an integer of from 1 to 3, preferably 2 or 3, and more preferably 3. n¹² represents an integer of from 0 to 4, preferably from 0 to 2, more preferably 0 or 1, and still more preferably 0, in view of luminance efficiency and prolonging of operational lifetime and storage lifetime. The reason for why the above ranges for n¹¹ are preferred is supposed as below. That is, the stability constant of the complex is high to suppress the deactivation without radiation so as to improve the luminance quantum efficiency as well as to suppress the decomposition of the complex so as to prolong the operational lifetime and the storage lifetime.

R²¹ to R²⁷ each represents a hydrogen atom or a substituent, and at least one of R²¹ to R²⁴, R²⁶ and R²⁷ is a deuterium atom. As the substituents, the same substituents as in R¹¹ to R¹⁷ are exemplified.

R²¹ preferably represents a hydrogen atom, a deuterium atom, a fluorine atom, a cyano group, an alkyl group, an aryl group, or a hetero aryl group, more preferably a hydrogen atom, a deuterium atom, a cyano group, or an aryl group, still more preferably a hydrogen atom, a deuterium atom or an aryl group, and especially preferably a deuterium atom.

R²² preferably represents a hydrogen atom, a deuterium atom, a fluorine atom, a cyano group, an alkyl group, an aryl group, or a hetero aryl group, more preferably a hydrogen atom, a deuterium atom, a cyano group, or a fluorine atom, still more preferably a hydrogen atom, a deuterium atom, or a cyano group, and especially preferably a deuterium atom or a cyano group.

R²³ preferably represents a hydrogen atom, a deuterium atom, a cyano group, an alkyl group, an aryl group, or a hetero aryl group, more preferably a hydrogen atom, a deuterium atom, or a cyano group, still more preferably a hydrogen atom or a deuterium atom, and especially preferably a deuterium atom.

R²⁴ preferably represents a hydrogen atom, a deuterium atom, an alkyl group, or an aryl group, more preferably a hydrogen atom or a deuterium atom, and still more preferably a deuterium atom.

R²⁵ preferably represents an alkyl group, an aryl group, or a hetero aryl group, more preferably an alkyl group or an aryl group, and still more preferably represents an aryl group. R²⁶ and R²⁷ each have the same meaning as R¹⁶ and R¹⁷, and the preferred range is also the same.

As the reason for why the above substituents are preferred as R²¹ to R²⁵, the similar explanation made for R¹¹ to R¹⁷ that the preferred range has an advantage in prolonging of operational lifetime is supposed.

R²¹ to R²⁷ may be combined to each other to form a ring, if possible.

L²¹, n²¹ and n²² each has the same meaning as L¹¹, n¹¹ and n¹², and the preferred range is also the same.

R³¹ to R³⁷ each represents a hydrogen atom or a substituent, and at least one of R³¹ to R³⁶ is a deuterium atom. As the substituents, the same groups as in R¹¹ to R¹⁷ are exemplified.

R³¹ preferably represents a hydrogen atom, a deuterium atom, a fluorine atom, a cyano group, an alkyl group, an aryl group, or a hetero aryl group, more preferably a hydrogen atom, a deuterium atom, a cyano group, or an aryl group, still more preferably a hydrogen atom, a deuterium atom or an aryl group, and especially preferably a deuterium atom or an aryl group.

R³² preferably represents a hydrogen atom, a deuterium atom, a fluorine atom, a cyano group, an alkyl group, an aryl group, or a hetero aryl group, more preferably a hydrogen atom, a deuterium atom, a cyano group, or a fluorine atom, still more preferably a hydrogen atom, a deuterium atom, or a fluorine atom, and especially preferably a deuterium atom.

R³³ preferably represents a hydrogen atom, a deuterium atom, a cyano group, an alkyl group, an aryl group, a hetero aryl group, or a group bonding to R³⁴ to form a benzofuran ring, more preferably a hydrogen atom, a deuterium atom, a cyano group, or a group bonding to R³⁴ to form a benzofuran ring, still more preferably a hydrogen atom, a deuterium atom, or a group bonding to R³⁴ to form a benzofuran ring, and especially preferably a deuterium atom or a group bonding to R³⁴ to form a benzofuran ring.

R³⁴ preferably represents a hydrogen atom, a deuterium atom, an alkyl group, an aryl group, or a group bonding to R³³ to form a benzofuran ring, more preferably a hydrogen atom, a deuterium atom, or a group bonding to R³³ to form a benzofuran ring, and still more preferably a deuterium atom or a group bonding to R³³ to form a benzofuran ring.

R³⁵ and R³⁶ each preferably represents a hydrogen atom, a deuterium atom, an alkyl group, an aryl group, or a group capable of forming a condensed structure by bonding (a benzo condensed ring is preferred), more preferably a hydrogen atom, a deuterium atom, or a group capable of forming a benzo condensed ring by bonding, still more preferably a hydrogen atom or a deuterium atom, and especially preferably a deuterium atom. R³⁷ preferably represents an alkyl group, an aryl group, or a hetero aryl group, more preferably an alkyl group or an aryl group, and still more preferably an aryl group.

As the reason for why the above substituents are preferred as R³¹ to R³⁶, the similar explanation made for R¹¹ to R¹⁷ that the preferred range has an advantage in prolonging of operational lifetime is supposed.

R³¹ to R³⁷ may be combined to each other to form a ring, if possible.

L³¹, n³¹ and n³² each has the same meaning as L¹¹, n¹¹ and n¹², and the preferred range is also the same.

An iridium complex used in the present invention may be a low molecular compound or a polymer compound including the iridium complex in the main or side chain thereof. The polymer compound may be a homopolymer, a copolymer with another monomer (preferably a monomer having a partial structure which has a function transporting a hole and/or an electron). The other monomer in the copolymer is preferably a monomer having a partial structure which has a charge transporting function. Examples of the monomer having a charge transporting function include the monomers having compounds as the partial structure, wherein the compounds are described later as a host material, a material contained in a hole transport layer, and a material contained in an electron transport layer, and preferably the monomer having compounds as the partial structure, wherein the compounds are described later as a host material, more preferably a monomer having a pyrrole skeleton as a partial structure, and still more preferably a monomer having an indole skeleton, a carbazole skeleton or an azacarbazole skeleton as the partial structure.

Specifically, N-vinylcarbazole, N-(4-vinylphenyl)carbazole, N-(4-vinylphenyl)indole, N-vinyl-2-azacarbazole, N-vinyl-3-azacarbazole and N-vinyl-4-azacarbazole are exemplified. The molecular weight of the polymer is preferably 5,000 or more and less than 1,000,000, more preferably 10,000 or more and less than 500,000. and still more preferably 10,000 or more an less than 100,000.

Specific examples of the iridium mateial are illustrated below which, however, are not to be construed to limit the invention in any way.

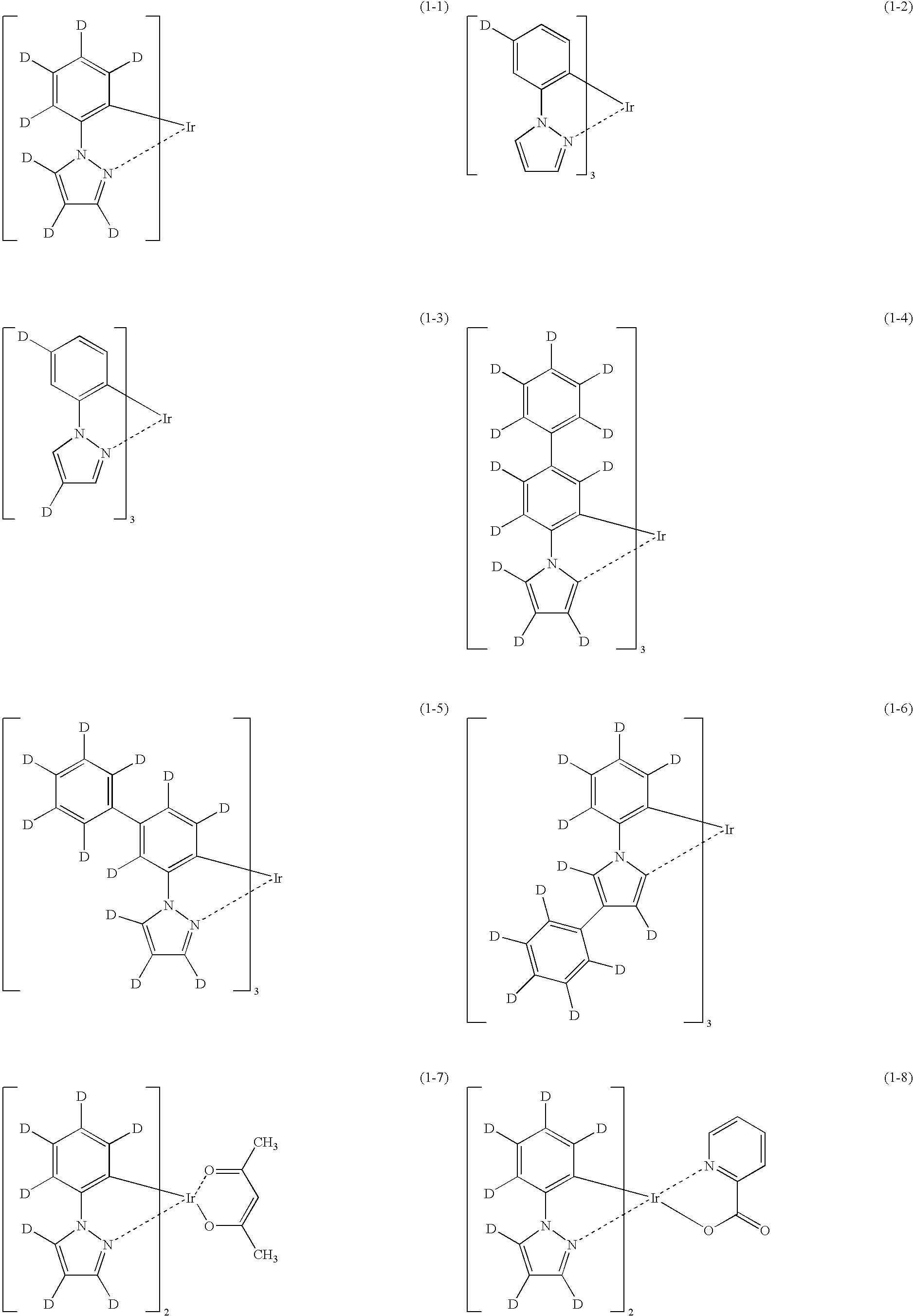

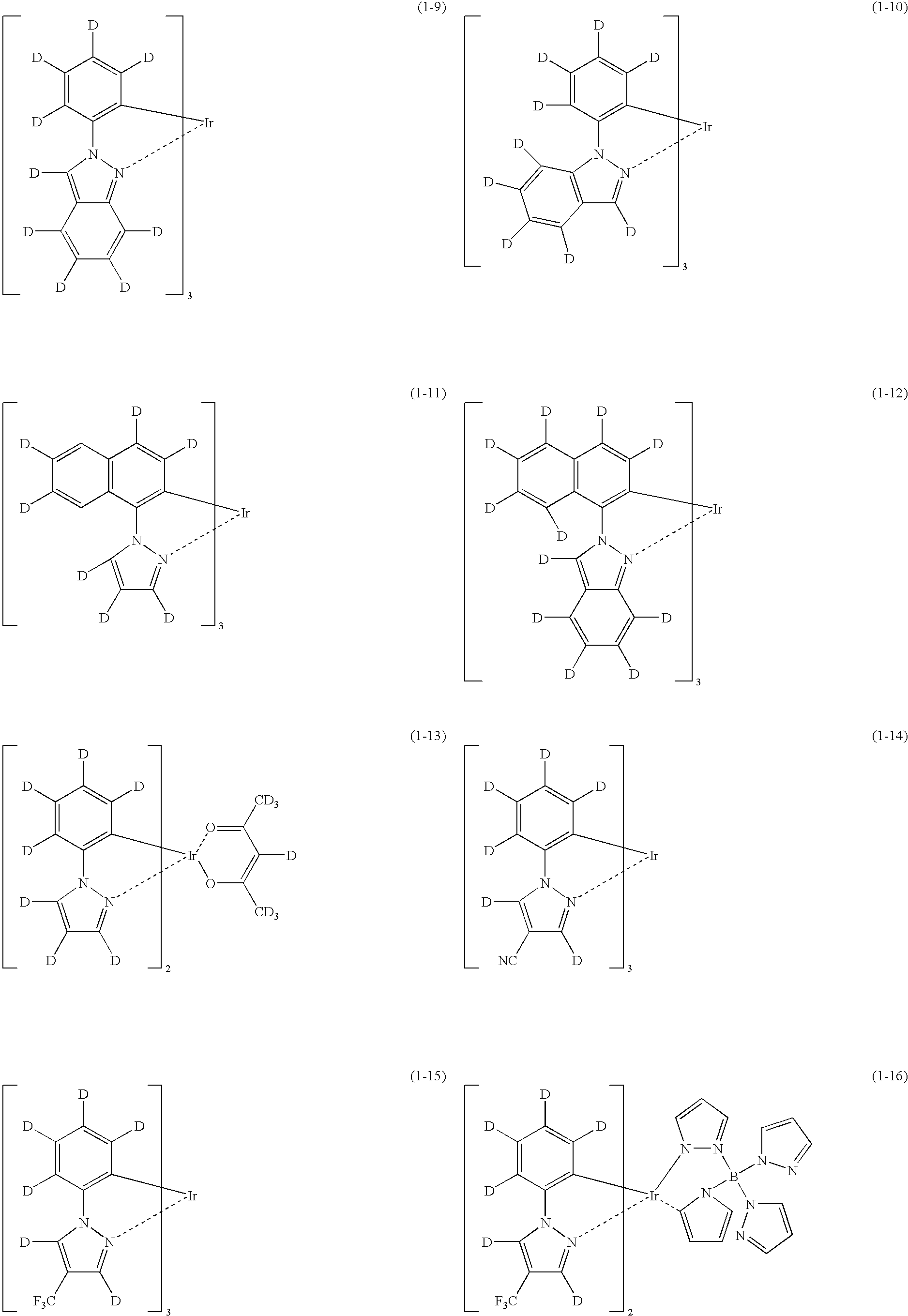

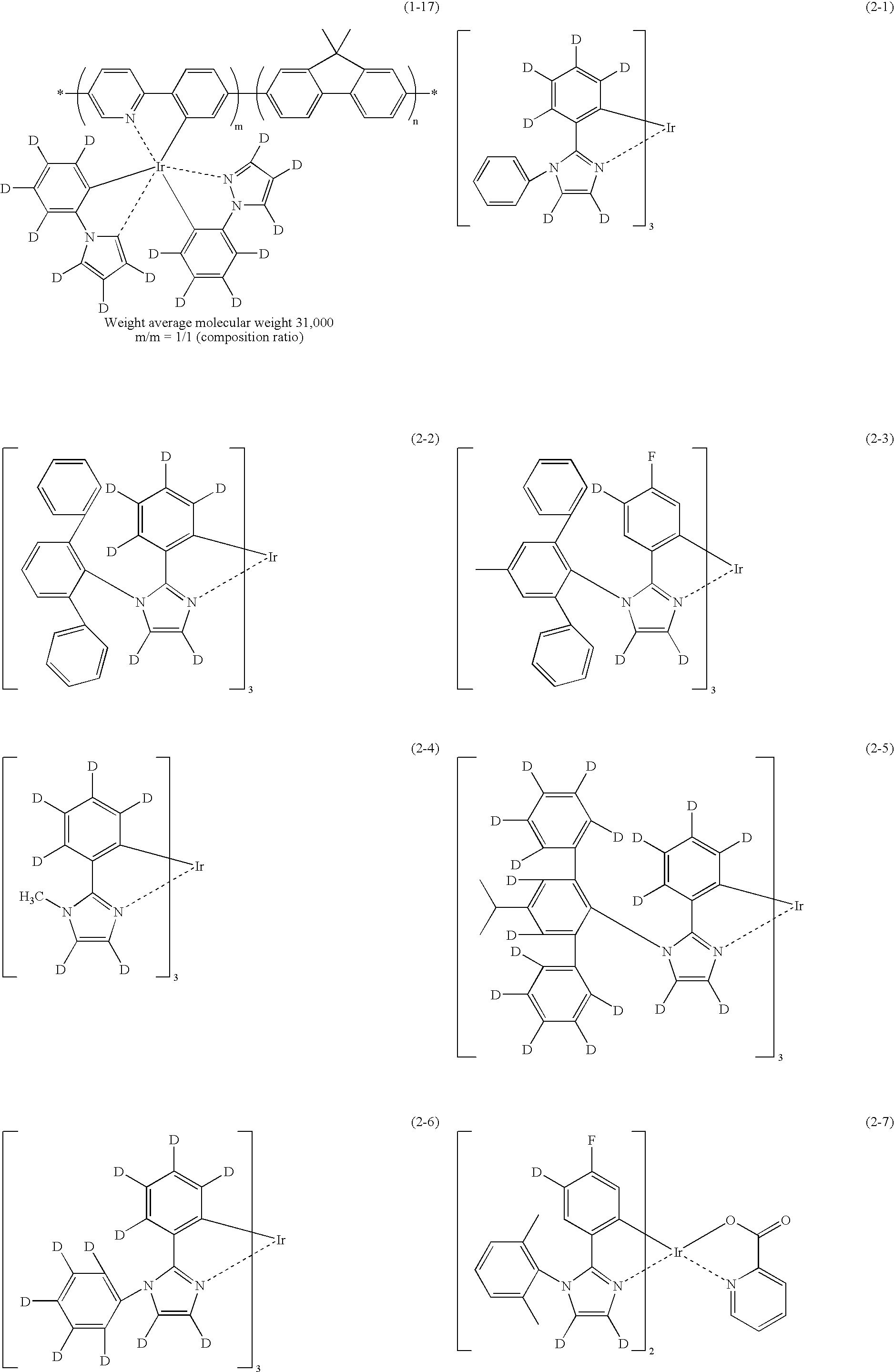

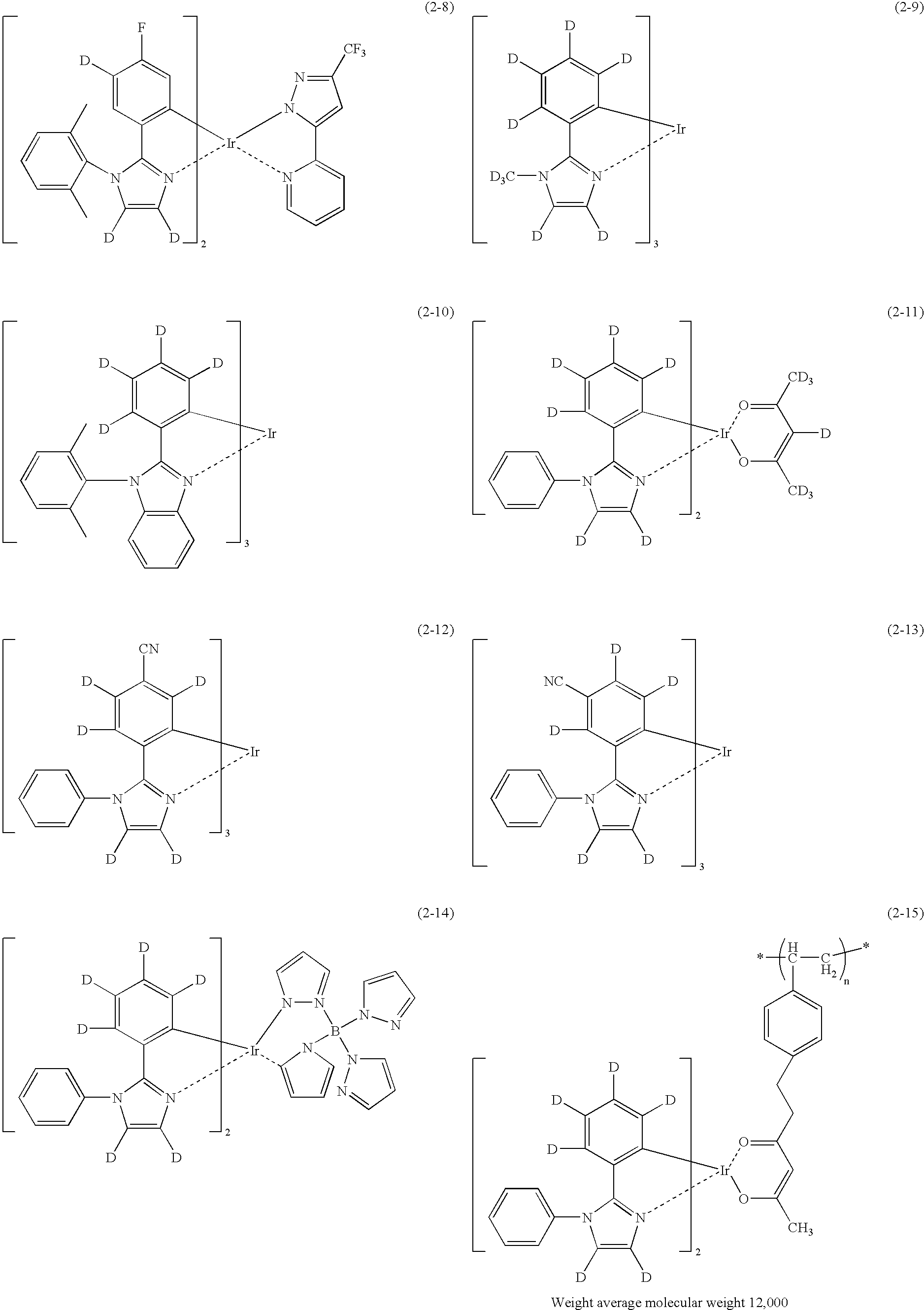

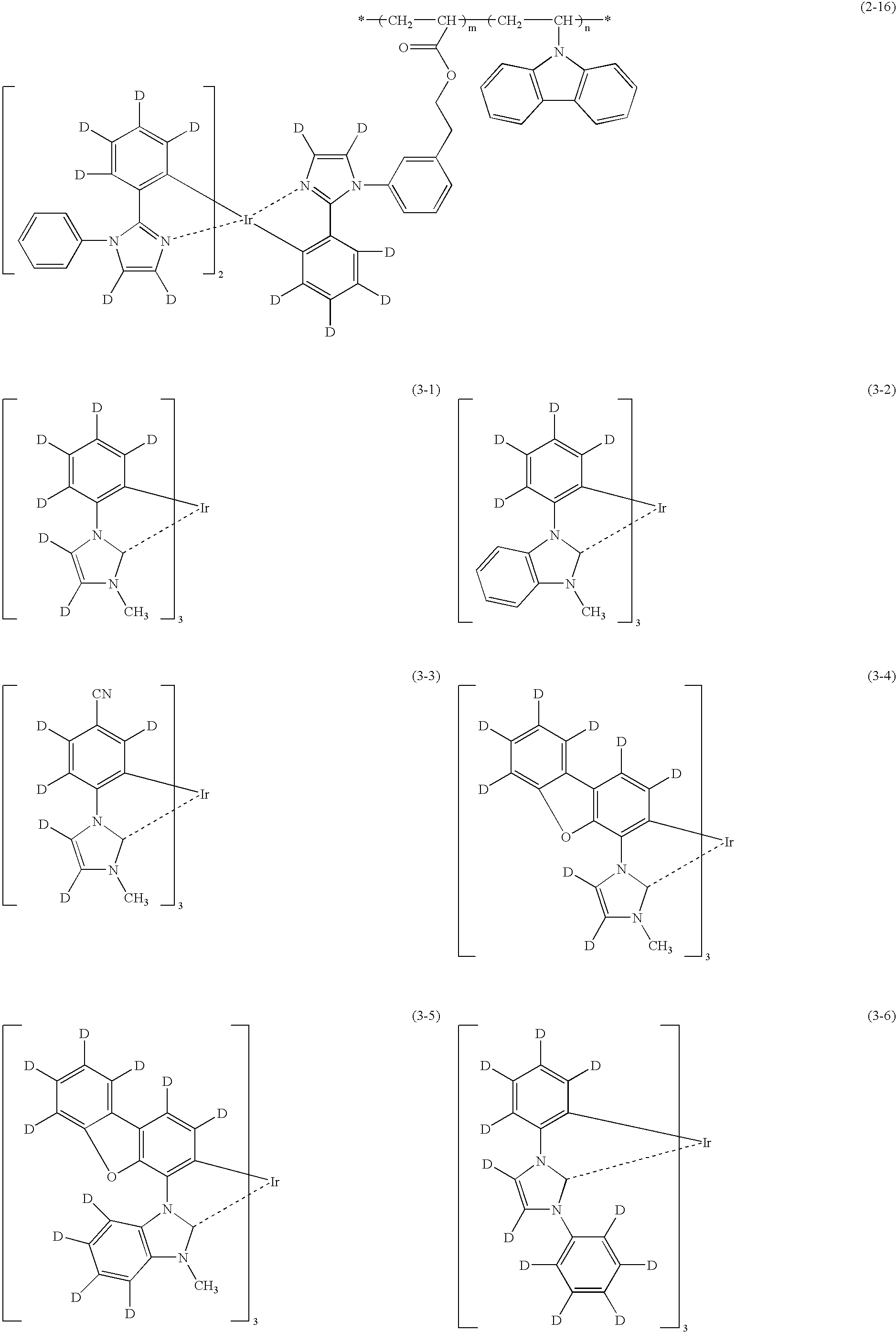

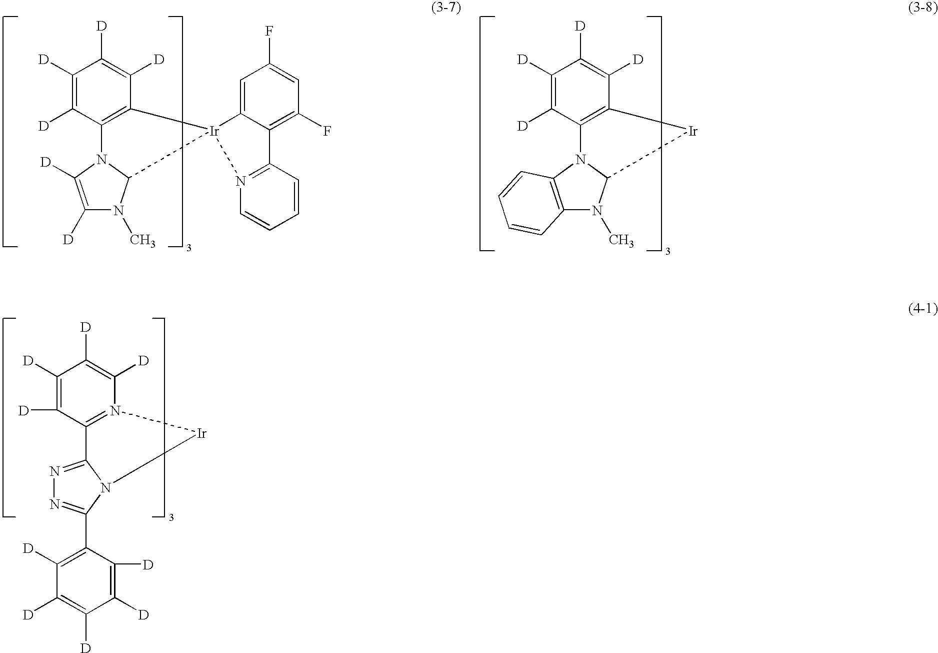

An iridium complex having a deuterium atom of the invention can be synthesized by referring to the method of a compound replacing the deuterium atom with a hydrogen atom. For example, the synthesizing methods of the compounds of replacing the deuterium atoms of formulae (1-1), (2-1) and (3-1) with hydrogen atoms are well known, and they can be synthesized similarly by using deuterated materials.

Deuterated materials are commercially available or can also be synthesized according to known methods. Further, deuterated materials can be synthesized by deuteration of the materials by deuterium (the deuterium may be generated from heavy water in the reaction system) in the presence of platinum and/or palladium catalysts. (Reference literature: Synlett, 1149 (2002), Org. Lett., 6, 1485 (2004), Tetrahedron Lett., 46, 6995 (2005), Adv. Synth. Catal., 348, 1025 (2006), Synlett, 845 (2005), and Synlett, 1385 (2005).) Organic electroluminescent device:

A device of the invention will be described in detail below.

A light-emitting device in the invention includes a substrate having thereon a cathode and an anode, and an organic layer between the electrodes, the organic layer including an organic electroluminescent layer (hereinafter sometimes referred to as “light-emitting layer”). (The organic layer is a layer containing an organic compound, and the layer may be a layer containing an organic compound alone or may be a layer containing an inorganic compound in addition to the organic compound.) In view of the properties of the light-emitting device, it is preferred that at least one electrode of the cathode and anode is transparent.

As an embodiment of stacking of the organic layers in the invention, the stacking is preferably in order of a hole transporting layer, a light-emitting layer, and an electron transporting layer from the anode side. Further, a charge blocking layer may be provided between the hole transporting layer and the light-emitting layer, or between the light-emitting layer and the electron transporting layer. A hole injecting layer may be provided between the anode and the hole transporting layer, and an electron injecting layer may be provided between the cathode and the electron transporting layer. Each layer may be divided into a plurality of secondary layers.

An organic electroluminescent device of the invention may be a white light-emitting device

Constituents of an organic electroluminescent device of the invention are described in detail below.

### Substrate:

A substrate for use in the invention is preferably a substrate that does not scatter or attenuate the light emitted from the organic layer. The specific examples of the materials of the substrate include inorganic materials, e.g., yttria stabilized zirconia (YSZ), glass, etc., and organic materials, such as polyester, e.g., polyethylene terephthalate, polybutylene phthalate, polyethylene naphthalate, etc., polystyrene, polycarbonate, polyether sulfone, polyallylate, polyimide, polycycloolefin, norbornene resin, poly(chloro-trifluoroethylene), etc.

When glass is used as a substrate, non-alkali glass is preferably used as the material for reducing elution of ions from the glass. Further, when soda lime glass is used, it is preferred to provide a barrier coat such as silica. In the case of organic materials, materials excellent in heat resistance, dimensional stability, solvent resistance, electrical insulating properties and processability are preferably used.

The form, structure and size of a substrate are not especially restricted, and these can be arbitrarily selected in accordance with the intended use and purpose of the light-emitting device. In general, a substrate is preferably in a plate-like form. The structure of a substrate may be a single layer structure or may be a layered structure, and may consist of a single member or may be formed of two or more members.

A substrate may be colorless and transparent, or may be colored and transparent, but from the point of not scattering or attenuating the light emitted from the light-emitting layer, a colorless and transparent substrate is preferably used.

A substrate can be provided with a moisture permeation preventing layer (a gas barrier layer) on the front surface or rear surface.

As the materials of the moisture permeation preventing layer (the gas barrier layer), inorganic materials such as silicon nitride and silicon oxide are preferably used. The moisture permeation preventing layer (the gas barrier layer) can be formed, for example, by a high frequency sputtering method.

When a thermoplastic substrate is used, if necessary, a hard coat layer and an undercoat layer may further be provided.

### Anode:

An anode is generally sufficient to have the function of the electrode to supply holes to an organic layer. The form, structure and size of an anode are not especially restricted, and these can be arbitrarily selected from known materials of electrode in accordance with the intended use and purpose of the light-emitting device. As described above, an anode is generally provided as a transparent anode.

As the materials of anode, for example, metals, alloys, metal oxides, electrically conductive compounds, and mixtures of these materials are preferably exemplified. The specific examples of the materials of anode include electrically conductive metal oxides, e.g., tin oxide doped with antimony or fluorine (ATO, FTO), tin oxide, zinc oxide, indium oxide, indium tin oxide (ITO), indium zinc oxide (IZO), etc., metals, e.g., gold, silver, chromium, nickel, etc., mixtures or layered products of these metals with electrically conductive metal oxides, inorganic electrically conductive substances, e.g., copper iodide, copper sulfide, etc., organic electrically conductive materials, e.g., polyaniline, polythiophene, polypyrrole, etc., layered products of these materials with ITO, etc. Of these materials, electrically conductive metal oxides are preferred, and ITO is especially preferred in view of productivity, high conductivity, transparency and the like.

An anode can be formed on the substrate in accordance with various methods arbitrarily selected from, for example, wet methods, e.g., a printing method, a coating method, etc., physical methods, e.g., a vacuum deposition method, a sputtering method, an ion plating method, etc., and chemical methods, e.g., a CVD method, a plasma CVD method, etc., taking the suitability with the material to be used in the anode into consideration. For example, in the case of selecting ITO as the material of an anode, the anode can be formed according to a direct current or high frequency sputtering method, a vacuum deposition method, an ion plating method, etc.

In an organic electroluminescent device of the invention, the position of the anode to be formed is not especially restricted and can be formed anywhere. The position can be arbitrarily selected in accordance with the intended use and purpose of the light-emitting device, but preferably provided on the substrate. In this case, the anode may be formed on the entire surface of one side of the substrate, or may be formed on a part of the organic layer.

As patterning in forming an anode, patterning may be performed by chemical etching such as by photo-lithography, may be carried out by physical etching such as by laser, may be performed by vacuum deposition or sputtering on a superposed mask, or a lift-off method and a printing method may be used.

The thickness of an anode can be optionally selected in accordance with the materials of the anode, so that cannot be regulated unconditionally, but the thickness is generally from 10 nm to 50 μm or so, and is preferably from 50 nm to 20 μm.

The value of resistance of an anode is preferably 10³Ω/□ or less, and more preferably 10²Ω/□ or less. In the case where an anode is transparent, the anode may be colorless and transparent, or colored and transparent. For the coupling out of luminescence from the transparent anode side, the transmittance is preferably 60% or more, and more preferably 70% or more.

In connection with transparent anodes, description is found in Yutaka Sawada supervised, Tomei Denkyoku-Maku no Shintenkai (New Development in Transparent Electrode Films), CMC Publishing Co., Ltd. (1999), and the description therein can be referred to. In the case of using a plastic substrate low in heat resistance, a transparent anode film-formed with ITO or IZO at a low temperature of 150° C. or less is preferred.

### Cathode:

A cathode is generally sufficient to have the function of the electrode to supply electrons to an organic layer. The form, structure and size of a cathode are not especially restricted, and these can be arbitrarily selected from known materials of electrode in accordance with the intended use and purpose of the light-emitting device.

As the materials of cathode, for example, metals, alloys, metal oxides, electrically conductive compounds, and mixtures of these materials are exemplified. The specific examples of the materials of cathode include alkali metals (e.g., Li, Na, K, Cs, etc.), alkaline earth metals (e.g., Mg, Ca, etc.), gold, silver, lead, aluminum, sodium-potassium alloy, lithium-aluminum alloy, magnesium-silver alloy, indium, rare earth metals, e.g., ytterbium, etc. These materials may be used by one kind alone, but from the viewpoint of the compatibility of stability and an electron injecting property, two or more kinds of materials are preferably used in combination.

As the materials constituting a cathode, alkali metals and alkaline earth metals are preferred of these materials in the point of electron injection, and materials mainly including aluminum are preferred for their excellent preservation stability.

The materials mainly including aluminum mean aluminum alone, alloys of aluminum with 0.01 to 10 mass % of alkali metal or alkaline earth metal, or mixtures of these (e.g., lithium-aluminum alloy, magnesium-aluminum alloy, etc.).

The materials of cathode are disclosed in JP-A-2-15595 and JP-A-5-121172, and the materials described in these patents can also be used in the invention.

A cathode can be formed by known methods with no particular restriction. For example, a cathode can be formed according to wet methods, e.g., a printing method, a coating method, etc., physical methods, e.g., a vacuum deposition method, a sputtering method, an ion plating method, etc., and chemical methods, e.g., a CVD method, a plasma CVD method, etc., taking the suitability with the material constituting the cathode into consideration. For example, in the case of selecting metals as the material of a cathode, the cathode can be formed with one or two or more kinds of materials at the same time or in order by sputtering, etc.

As patterning in forming a cathode, patterning may be performed by chemical etching such as by photo-lithography, may be carried out by physical etching such as by laser, may be performed by vacuum deposition or sputtering on a superposed mask, or a lift-off method and a printing method may be used.

The position of the cathode to be formed is not especially restricted and can be formed anywhere in the invention. The cathode may be formed on the entire surface of the organic layer, or may be formed on a part of the organic layer.

A dielectric layer including fluoride or oxide of alkali metal or alkaline earth metal may be inserted between the cathode and the organic layer in a thickness of from 0.1 to 5 nm. The dielectric layer can be regarded as one kind of an electron injecting layer. The dielectric layer can be formed, for example, according to a vacuum deposition method, a sputtering method, an ion plating method, etc.

The thickness of a cathode can be optionally selected in accordance with the materials of the cathode, so that cannot be regulated unconditionally, but the thickness is generally from 10 nm to 5 μm or so, and is preferably from 50 nm to 1 μm.

A cathode may be transparent or opaque. A transparent cathode can be formed by forming a thin film of the materials of the cathode in a thickness of from 1 to 10 nm, and further stacking transparent conductive materials such as ITO and IZO.

### Organic Layer:

Organic layers in the invention will be described below.

An organic electroluminescent device of the invention has at least one organic layer, preferably has at least three layers of a hole transporting layer, a light-emitting layer and an electron transporting layer. As organic layers other than the organic light-emitting layer, as described above, a hole transporting layer, an electron transporting layer, a charge blocking layer, a hole injecting layer and an electron injecting layer are exemplified. A layer promoting injecting a hole into the light-emitting layer, a layer blocking an electron or a layer blocking an exciton is preferably provided between the hole transporting layer and the light-emitting layer.

### Formation of Organic Layers:

In an organic electroluminescent device of the invention, each layer constituting organic layers can be preferably formed by any of dry film-forming methods such as a vacuum deposition method, a sputtering method, etc., a transfer method, and a printing method.

### Light-Emitting Layer:

The light-emitting layer is a layer having functions to receive, at the time of applying an electric field, holes from the anode, hole injecting layer or hole transporting layer, and electrons from the cathode, electron injecting layer or electron transporting layer, and to offer the field of recombination of holes and electrons to emit light.

A light-emitting layer in the invention may consist of light-emitting materials alone, or may comprise a mixed layer of a host material and a light-emitting material. The light-emitting material may be a fluorescent material or may be a phosphorescent material. Dopant may be one or two or more kinds. The host material is preferably a charge transporting material, and one or two or more host materials may be used. For example, the constitution of the mixture of an electron transporting host material and a hole transporting host material is exemplified. Further, a material not having an electron transporting property and not emitting light may be contained in the light-emitting layer.

A light-emitting layer may include one layer alone or two or more layers, and in the case of two or more layers, each layer may emit light of color different from other layers.

### Light-Emitting Material:

The examples of fluorescent materials that can be used in the invention include various metal complexes represented by metal complexes of benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, condensed aromatic compounds, perinone derivatives, oxadiazole derivatives, oxazine derivatives, aldazine derivatives, pyraridine derivatives, cyclopentadiene derivatives, bisstyryl-anthracene derivatives, quinacridone derivatives, pyrrolo-pyridine derivatives, thiadiazolopyridine derivatives, cyclopentadiene derivatives, styrylamine derivatives, diketopyrrolopyrrole derivatives, aromatic dimethylidyne compounds, 8-quinolinol derivatives, and pyrromethene derivatives, polymer compounds such as polythiophene, polyphenylene, polyphenylenevinylene, and compounds such as organic silane derivatives.

The examples of phosphorescent materials that can be used in the invention include complexes containing a transition metal atom or a lanthanoid atom.

The transition metal atoms are not especially restricted, but ruthenium, rhodium, palladium, tungsten, rhenium, osmium, iridium and platinum are preferably exemplified, and rhenium, iridium and platinum are more preferred.

As lanthanoid atoms, lanthanum, cerium, praseodymium, neodymium, samarium, europium, gadolinium, terbium, dysprosium, holmium, erbium, thulium, ytterbium, and lutecium are exemplified. Of these lanthanoid atoms, neodymium, europium and gadolinium are preferred.

As the examples of ligands of complexes, the ligands described, for example, in G. Wilkinson et al., Comprehensive Coordination Chemistry, Pergamon Press (1987), H. Yersin, Photochemistry and Photophysics of Coordination Compounds, Springer-Verlag (1987), and Akio Yamamoto, Yuki Kinzoku Kagaku—Kiso to Oyo—(Organic Metal Chemistry—Elements and Applications), Shokabo Publishing Co. (1982) are exemplified.

As the specific examples of ligands, halogen ligands (preferably a chlorine ligand), nitrogen-containing heterocyclic ligands (e.g., phenylpyridine, benzoquinoline, quinolinol, bipyridyl, phenanthroline, etc.), diketone ligands (e.g., acetylacetone, etc.), carboxylic acid ligands (e.g., acetic acid ligand, etc.), carbon monoxide ligands, isonitrile ligands, and cyano ligands are preferably exemplified, and more preferably nitrogen-containing heterocyclic ligands. These complexes may have one transition metal atom in a compound, or may be the so-called polynuclear complexes having two or more transition metal atoms. They may contain metal atoms of different kinds at the same time.

An iridium complex of the invention can be used in combination with other guest materials in the range not reducing the effect of the invention.

The emission maximum wavelength of the phosphorescent material (containing an iridium complex of the invention) contained in a light-emitting device of the invention is preferably from 350 nm to 500 nm, more preferably from 370 to 490 nm, still more preferably from 400 to 480 μm, and especially preferably from 420 to 470 nm.

A phosphorescent material containing an iridium complex of the invention is contained in a light-emitting layer in an amount of preferably from 0.1 to 40 mass % (weight %), more preferably from 0.5 to 20 mass %. When a phosphorescent material other than an iridium complex is used in combination with the iridium complex, the amount of the iridium complex is preferably 50 mass % or more, more preferably 80 mass % or more with respect to the total amount of phosphorescent materials.

When an iridium complex is used as a phosphorescent material, it is generally used in an amount of 1 to 50 mass parts (weight parts), more preferably 5 to 30 mass parts with respect to 100 mass parts of a host material.

### Host Material:

As the host materials contained in a light-emitting layer of the invention, pyrrole host materials (including condensed rings of an aromatic hydrocarbon ring or a heterocyclic ring) and hydrocarbon host materials (preferably materials consisting of benzene rings alone) are preferred, pyrrole host materials are more preferred, indole host materials, carbazole host materials, azaindole host materials and azacarbazole host materials are still more preferred, and indole host materials are especially preferred. Further, materials having a diarylamine skeleton, materials having a pyridine skeleton, materials having a pyrazine skeleton, materials having triazine skeleton, materials having arylsilane skeleton, materials exemplified as those used in a hole injecting layer, a hole transporting layer, an electron injecting layer and an electron transporting layer as described later, are exemplified.

The degree of charge transfer of the host material contained in the light-emitting layer is preferably 1×10⁻⁶ cm²/Vs or more and 1×10⁻¹ cm²/Vs or less, more preferably 5×10⁻⁶ cm²/Vs or more and 1×10⁻² cm²/Vs or less, still more preferably 1×10⁻⁵ cm² Vs or more and 1×10⁻² cm²/Vs or less, and especially preferably 5×10⁻⁵ cm²/Vs or more and 1×10⁻² cm²/Vs or less.

The glass transition points of the host materials, and the electron transporting materials and the hole transporting materials contained in an organic electroluminescent device of the invention are preferably 90° C. or more and 400° C. or less, more preferably 100° C. or more and 380° C. or less, still more preferably 120° C. or more and 370° C. or less, and especially preferably 140° C. or more and 360° C. or less.

The T₁ level (the energy level in the state of minimum triplet excitation) of the host material contained in a light-emitting device of the invention is preferably 60 kcal/mol or more (251.4 kJ/mol or more) and 90 kcal/mol or less (377.1 kJ/mol or less), more preferably 62 kcal/mol or more (259.78 kJ/mol or more) and 85 kcal/mol or less (356.15 kJ/mol or less), and still more preferably 65 kcal/mol or more (272.35 kJ/mol or more) and 80 kcal/mol or less (335.2 kJ/mol or less).

When T₁ level is less than the greatest lower bound, emission efficiency of the device, in particular external quantum efficiency, is liable to lower, while when T₁ level is higher than the least upper bound, high voltage is required for the injection of charge, so that the consumed electric power is liable to increase.

The T₁ level (the energy level in the state of minimum triplet excitation) of the layer contiguous to the light-emitting layer is preferably 60 kcal/mol or more (251.4 kJ/mol or more) and 90 kcal/mol or less (377.1 kJ/mol or less), more preferably 62 kcal/mol or more (259.78 kJ/mol or more) and 85 kcal/mol or less (356.15 kJ/mol or less), and still more preferably 65 kcal/mol or more (272.35 kJ/mol or more) and 80 kcal/mol or less (335.2 kJ/mol or less).

When T₁ level is less than the greatest lower bound, emission efficiency of the device, in particular external quantum efficiency, is liable to lower, while when T₁ level is higher than the least upper bound, high voltage is required for the injection of charge, so that the consumed electric power is liable to increase.

The thickness of the light-emitting layer is not especially limited, but is generally preferably from 1 to 500 nm, more preferably from 5 to 200 nm, and still more preferably from 10 to 100 nm.

### Hole Injecting Layer and Hole Transporting Layer:

The hole injecting layer and the hole transporting layer are layers having a function to receive holes from the anode or anode side and transport the holes to the cathode side. The hole injecting layer and the hole transporting layer are specifically preferably the layers containing carbazole derivatives, azacarbazole derivatives, indole deivateives, azaindole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidyne compounds, porphyrin compounds, organic silane derivatives, carbon, and various kinds of metal complexes represented by Ir complex, having phenylazole, or phenylazine as the ligand.

An electron accepting dopant can be contained in the positive hole injecting layer or positive hole transporting layer of an organic EL device of the invention. As the electron accepting dopants to be introduced to the hole injecting layer or hole transporting layer, inorganic compounds and organic compounds can be used so long as they are electron accepting and have a property of capable of oxidizing an organic compound.

Specifically, as the inorganic compounds, halogenated metals, e.g., ferric chloride, aluminum chloride, gallium chloride, indium chloride, antimony pentachloride, etc., and metal oxides, e.g., vanadium pentoxide, molybdenum trioxide, etc., are exemplified.

When dopants are organic compounds, the compounds having as a substituent a nitro group, halogen, a cyano group, or a trifluoromethyl group, quinone compounds, acid anhydride compounds, and fullerene are preferably used.

Besides the above compounds, the compounds disclosed in JP-A-6-212153, JP-A-11-111463, JP-A-11-251067, JP-A-2000-196140, JP-A-2000-286054, JP-A-2000-315580, JP-A-2001-102175, JP-A-2001-160493, JP-A-2002-252085, JP-A-2002-56985, JP-A-2003-157981, JP-A-2003-217862, JP-A-2003-229278, JP-A-2004-342614, JP-A-2005-72012, JP-A-2005-166637 and JP-A-2005-209643 can be preferably used.

Of these compounds, hexacyanobutadiene, hexacyanobenzene, tetracyanoethylene, tetracyanoquinodimethane, tetrafluorotetracyanoquinodimethane, p-fluoranyl, p-chloranyl, p-bromanyl, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthoquinone, 1,5-dinitronaphthalene, 9,10-anthraquinone, 1,3,6,8-tetranitrocarbazole, 2,4,7-trinitro-9-fluorenone, 2,3,5,6-tetracyanopyridine, and fullerene C₆₀ are preferred, hexacyanobutadiene, hexacyanobenzene, tetracyanoethylene, tetracyanoquinodimethane, tetrafluorotetracyanoquinodimethane, p-fluoranyl, p-chloranyl, p-bromanyl, 2,6-dichlorobenzoquinone, 2,5-dichlorobenzoquinone, 2,3-dichloronaphthoquinone, 1,2,4,5-tetracyanobenzene, 2,3-dichloro-5,6-dicyanobenzoquinone, and 2,3,5,6-tetracyanopyridine are more preferred, and tetrafluorotetracyanoquinodimethan is especially preferred.

These electron accepting dopants may be used by one kind alone, or two or more kinds may be used in combination. The amount of the electron accepting dopant to be used differs according to the kind of the material, but the amount is preferably from 0.01 to 50 mass % to the material of the positive hole transporting layer, more preferably from 0.05 to 20 mass %, and still more preferably from 0.1 to 10 mass %.

The thickness of the hole injecting layer and hole transporting layer is preferably 500 nm or less from the viewpoint of lowering driving voltage.

The thickness of the hole transporting layer is preferably from 1 to 500 nm, more preferably from 5 to 200 nm, and still more preferably from 10 to 100 nm. The thickness of the hole injecting layer is preferably from 0.1 to 200 nm, more preferably from 0.5 to 100 nm, and still more preferably from 1 to 100 nm.

The hole injecting layer and the hole transporting layer may be a single layer structure comprising one or two or more of the above materials, or may be a multilayer structure comprising a plurality of layers of the same or different compositions.

### Electron Injecting Layer and Electron Transporting Layer:

The electron injecting layer and the electron transporting layer are layers having a function to receive electrons from the cathode or cathode side and transport the electrons to the anode side. The electron injecting layer and the electron transporting layer are specifically preferably layers containing triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, tetracarboxylic anhydride of aromatic rings such as naphthalene, perylene, etc., a phthalocyanine derivative, various metal complexes represented by metal complexes of 8-quinolinol derivatives, metalphthalocyanine, metal complexes having benzoxazole, benzothiazole as the ligand, organic silane derivative, etc.

An electron donating dopant can be contained in the electron injecting layer or electron transporting layer of an organic EL elemental device of the invention. Any compound can be used as the electron donating dopant to be introduced to the electron injecting layer or electron transporting layer, so long as the compound is electron accepting and has a property of capable of reducing an organic compound, and alkali metal salts, e.g., Li, alkaline earth metals, e.g., Mg, transition metals containing a rare earth metal, and reducing organic compounds are preferably used as the electron donating dopant. As the metals, metals having a work function of 4.2 eV or less can be preferably used, and specifically Li, Na, K, Be, Mg, Ca, Sr, Ba, Y, Cs, La, Sm, Gd and Yb are exemplified. As the reducing organic compounds, e.g., nitrogen-containing compounds, sulfur-containing compounds, and phosphorus-containing compounds are exemplified.

Besides the above, the materials disclosed in JP-A-6-212153, JP-A-2000-196140, JP-A-2003-68468, JP-A-2003-229278, and JP-A-2004-342614 can be used.

These electron donating dopants may be used alone, or two or more kinds may be used in combination. The use amount of the electron donating dopants differs according to the kind of the material, but the amount is preferably from 0.1 to 99 mass % to the material of the electron transporting layer, more preferably from 1.0 to 80 mass %, and especially preferably from 2.0 to 70 mass %.

The thickness of each of the electron injecting layer and electron transporting layer is preferably 500 nm or less from the viewpoint of lowering driving voltage.

The thickness of the electron transporting layer is preferably from 1 to 500 nM, more preferably from 5 to 200 nm, and still more preferably from 10 to 100 nm. The thickness of the electron injecting layer is preferably from 0.1 to 200 nm, more preferably from 0.2 to 100 nm, and still more preferably from 0.5 to 50 nm.

The electron injecting layer and the electron transporting layer may be a single layer structure comprising one or two or more of the above materials, or may be a multilayer structure comprising a plurality of layers of the same or different compositions.

### Hole Blocking Layer:

A hole blocking layer is a layer having a function of preventing the positive holes transported from the anode side to the light-emitting layer from passing through to the cathode side. In the invention, a hole blocking layer can be provided as the organic layer contiguous to the light-emitting layer on the cathode side.

As the examples of the organic compounds constituting the hole blocking layer, aluminum complexes, e.g., aluminum (III) bis(2-methyl-8-quinolinato)-4-phenylphenolate (abbreviated to BAlq), etc., triazole derivatives, phenanthroline derivatives, e.g., 2,9-dimethyl-4,7-diphenyl-1,10-phenanthroline (abbreviated to BCP), etc., are exemplified.

The thickness of the hole blocking layer is preferably from 1 to 500 nm, more preferably from 5 to 200 nm, and still more preferably from 10 to 100 nm.

The hole blocking layer may be a single layer structure comprising one or two or more of the above materials, or may be a multilayer structure comprising a plurality of layers of the same or different compositions.

### Protective Layer:

In the invention, an organic EL device may be completely protected with a protective layer.

It is sufficient for the materials to be contained in the protective layer to have a function capable of restraining the substances accelerating deterioration of device, e.g., water, oxygen, etc., from entering the device.

The specific examples of such materials include metals, e.g., In, Sn, Pb, Au, Cu, Ag, Al, Ti, Ni, etc., metal oxides, e.g., MgO, SiO, SiO₂, Al₂O₃, GeO, NiO, CaO, BaO, Fe₂O₃, Y₂O₃, TiO₂, etc., metal nitrides, e.g., SiNe, SiNₓO_{y}, etc., metal fluorides, e.g., MgF₂, LiF, AlF₃, CaF₂, etc., polyethylene, polypropylene, polymethyl methacrylate, polyimide, polyurea, polytetrafluoroethylene, polychlorotrifluoroethylene, polydichlorodifluoroethylene, copolymers of chlorotrifluoro-ethylene with dichlorodifluoroethylene, copolymers obtained by copolymerization of a monomer mixture containing tetrafluoroethylene and at least one comonomer, fluorine-containing copolymers having a cyclic structure on the main chain of the copolymer, water absorptive substances having a water absorption rate of not lower than 1%, moisture proofing substances having a water absorption rate of not higher than 0.1%.

The forming method of the protective layer is not especially restricted and, for example, a vacuum deposition method, a sputtering method, a reactive sputtering method, an MBE (molecular beam epitaxy) method, a cluster ion beam method, an ion plating method, a plasma polymerization method (a high frequency excitation ion plating method), a plasma CVD method, a laser CVD method, a heat CVD method, a gas source CVD method, a coating method, a printing method, a transfer method, etc., can be applied to the invention.

### Sealing:

An organic electroluminescent device of the invention may be completely sealed in a sealing container.

Further, a water absorber or an inert liquid may be filled in the space between the sealing container and the light-emitting device. The water absorber is not especially restricted and, for example, barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, magnesium oxide, etc., can be exemplified. The inert liquid is not particularly limited and, for example, paraffins, liquid paraffins, fluorine solvents, such as perfluoroalkane, perfluoroamine, perfluoroether, etc., chlorine solvents, and silicone oils are exemplified.

Luminescence can be obtained by the application of DC (if necessary, an alternating current factor may be contained) voltage (generally from 2 to 15 V) or DC electric current between the anode and cathode of the organic electroluminescent device of the invention.

In connection with the driving methods of the organic electroluminescent device of the invention, the driving methods disclosed in JP-A-2-148687, JP-A-6-301355, JP-A-5-29080, JP-A-7-134558, JP-A-8-234685, JP-A-8-241047, Japanese Patent 2784615, and U.S. Pat. Nos. 5,828,429 and 6,023,308 can be used.

The external quantum efficiency of a light-emitting device of the invention is preferably 5% or more, more preferably 10% or more, and still more preferably 13% or more. As the value of external quantum efficiency, the maximum value of the external quantum efficiency at the time of driving a device at 20° C., or the value of the external quantum efficiency near 100 to 300 cd/m² at the time of driving an elemental device at 20° C. can be used.

The internal quantum efficiency of a light-emitting device of the invention is preferably 30% or more, more preferably 50% or more, and still more preferably 70% or more. The internal quantum efficiency of a device is computed by dividing the external quantum efficiency by the efficiency of taking out light. In ordinary organic electroluminescent devices, the efficiency of taking out light is about 20%, but it is possible to make the efficiency of taking out light 20% or more by various contrivances such as the shape of a substrate, the shape of electrodes, the thickness of an organic layer, the thickness of an inorganic layer, the refractive index of an organic layer, and the refractive index of an inorganic layer.

The invention will be described specifically with reference to examples, but the embodiments of the invention are not restricted thereto. The compounds used in the examples are shown below.

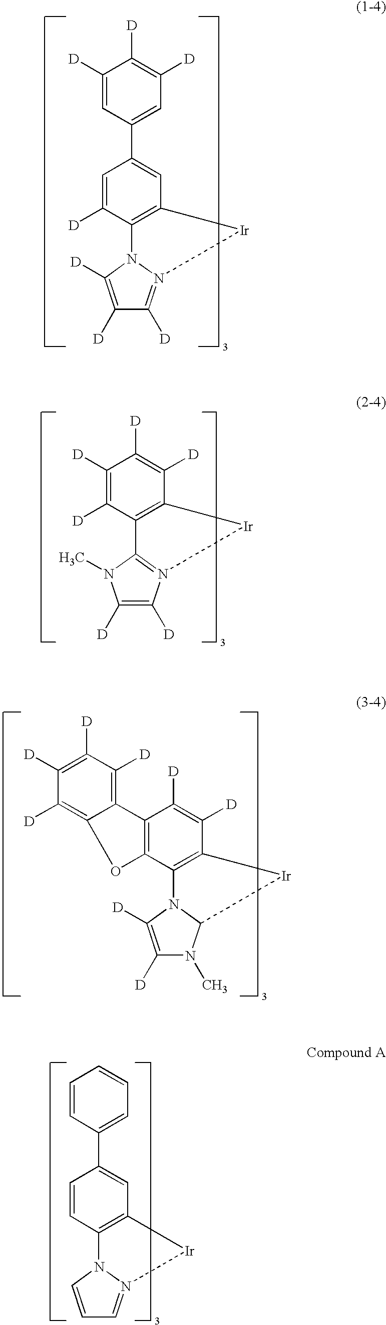

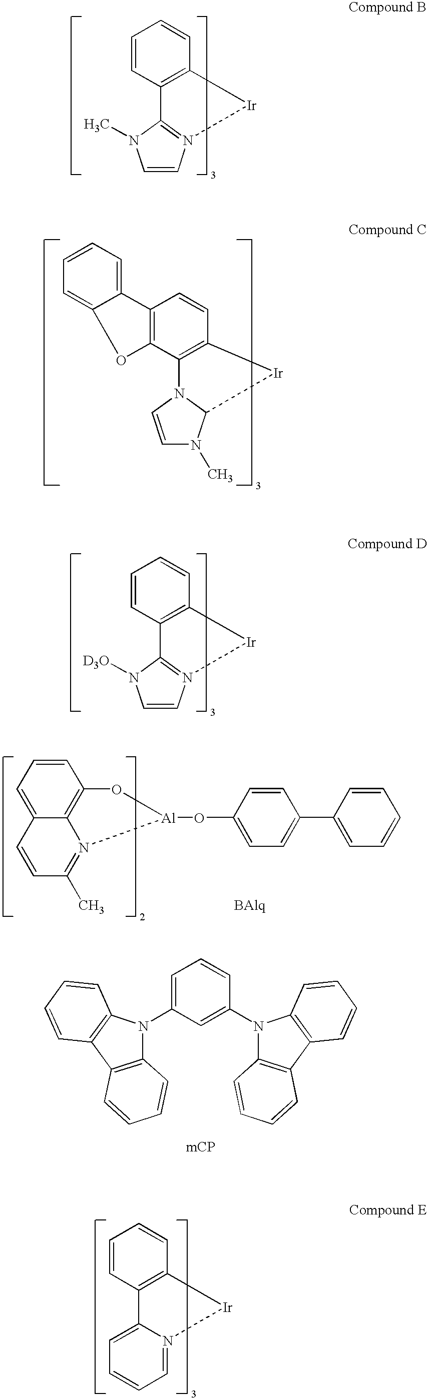

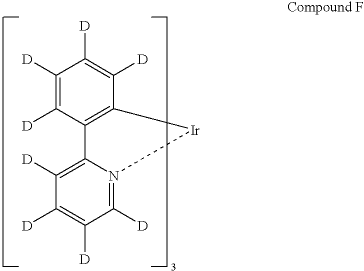

### Comparative Example 1

A cleaned ITO substrate is placed in a vacuum evaporator, copper phthalocyanine is deposited on the substrate in a thickness of 10 nm, and NPD (N,N′-di-α-naphthyl-N,N′-diphenyl)benzidine is deposited thereon in a thickness of 40 μm. Compound A (light-emitting material) and compound mCP (host material) (T1 value in a film state: 65 kcal/mol. The T1 value is derived from a shorter wavelength edge in the measured spectrum of emission of phosphorescence of a thin film of the material, wherein the measurement is performed as follows: a film is formed with the material on a cleaned quartz glass substrate in a thickness of about 50 nm by vacuum deposition, and the spectrum of emission of phosphorescence of the thin film is measured with a fluorescence spectrophotometer Model F-7000 (manufactured by Hitachi High Technologies) under a liquid nitrogen temperature.) in the ratio of 12/88 (by mass) are deposited on the above deposited film in a thickness of 30 nm, then BAlq is deposited thereon in a thickness of 6 nm, and then Alq (tris(8-hydroxyquinoline) aluminum complex) is deposited on the above film in a thickness of 20 nm. Lithium fluoride is deposited thereon in a thickness of 3 nm, followed by deposition of aluminum in a thickness of 60 nm thereon to prepare an organic EL device (hereinafter abbreviated to “device”). The obtained EL device is subjected to application of DC constant voltage with a source measure unit Model 2400 (manufactured by Toyo Technica Co., Ltd.) to emit light. It is confirmed that the emission of phosphorescence originating in compound A is observed. Half life of luminance of the emission of phosphorescence is obtained as follows.

Half life of luminance: the device is driven by low current of 500 cd/m² at start and the time elapsed before emission luminance drops to 250 cd/m² is measured, wherein the emission luminance is measured by the luminance meter SR-3 manufactured by TOPCON. The increase in drive voltage ΔV is evaluated, from when the emission luminance is initially 500 cd/m² to when the emission luminance drops to 250 cd/m².

### Comparative Example 2

A device is manufactured and evaluated in the same manner as in Comparative Example 1 except for using compound B in place of compound A in Comparative Example 1. The emission of phosphorescence originating in compound B is observed.

### Comparative Example 3

A device is manufactured and evaluated in the same manner as in Comparative Example 1 except for using compound C in place of compound A in Comparative Example 1. The emission of phosphorescence originating in compound C is observed.

### Comparative Example 4

A device is manufactured and evaluated in the same manner as in Comparative Example 1 except for using compound D in place of compound A in Comparative Example 1. The emission of phosphorescence originating in compound D is observed.

### Comparative Example 5

A device is manufactured and evaluated in the same manner as in Comparative Example 1 except for using compound E in place of compound A in Comparative Example 1. The emission of phosphorescence originating in compound E is observed.

### Comparative Example 6

A device is manufactured and evaluated in the same manner as in Comparative Example 1 except for using compound F in place of compound A in Comparative Example 1. The emission of phosphorescence originating in compound F is observed.

### Example 1

A device is manufactured and evaluated in the same manner as in Comparative Example 1 except for using compound (1-4) in place of compound A in Comparative Example 1. The emission of phosphorescence originating in compound (1-4) is observed.

### Example 2

A device is manufactured and evaluated in the same manner as in Comparative Example 1 except for using compound (2-4) in place of compound B in Comparative Example 2. The emission of phosphorescence originating in compound (2-4) is observed.

### Example 3

A device is manufactured and evaluated in the same manner as in Comparative Example 1 except for using compound (3-4) in place of compound C in Comparative Example 3. The emission of phosphorescence originating in compound (3-4) is observed.

A device is manufactured and evaluated in the same manner as in Example 1 except for using compound G in place of compound mCP (host material) in Example 1. The emission of phosphorescence originating in compound (1-4) is observed.

The results obtained are shown in relative values in Table 1 below.

TABLE 1

| | |
|---|---|
| | Compound G |
| 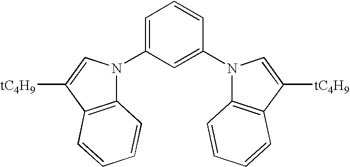 | |

| | Half | Increase in drive |
|---|---|---|
| Example No. | Life of Luminance (relative value) | voltage (ΔV) |
| Comparative | 1.0 | 1.8 V |
| Example 1 | | |
| Comparative | 2.2 (relative value to Comparative | 1.7 V |
| Example 2 | Example 1) | |
| Comparative | 0.8 (relative value to Comparative | 2.1 V |
| Example 3 | Example 1) | |
| Comparative | 1.0 (relative value to Comparative | 1.9 V |
| Example 4 | Example 1) | |
| Comparative | 3.0 (relative value to Comparative | 1.6 V |
| Example 5 | Example 1) | |
| Comparative | 3.1 (relative value to Comparative | 1.5 V |
| Example 6 | Example 1) | |
| Example 1 | 4.3 (relative value to Comparative | 0.8 V |
| | Example 1) | |
| Example 2 | 2.2 (relative value to Comparative | 0.6 V |
| | Example 2) | |
| Example 3 | 1.9 (relative value to Comparative | 1.2 V |
| | Example 3) | |
| Example 4 | 4.5 (relative value to Comparative | 0.7 V |
| | Example 3) | |

The following facts are understood from the results in Table 1.

From the comparison of Comparative Example 5 and Comparative Example 6, it can be seen that the effect of substitution of the deuterium atom is hardly obtained even when a deuterium atom is substituted on the SP2 carbon atom of the compound not having a 5-membered heterocyclic structure.

From the comparison of Comparative Example 2 and Comparative Example 4, it can be seen that substitution of the deuterium atom on the SP3 carbon atom rather produces a contrary result even when the compound has a 5-membered heterocyclic structure.

The effect of substitution of a deuterium atom is obtained only when the deuterium atom is substituted on the SP2 carbon atom of the compound having a 5-membered heterocyclic structure (comparisons of Comparative Example 1 with Example 1, Comparative Example 2 with Example 2, and Comparative Example 3 with Example 3, respectively).

From the comparison of Comparative Example 1, Example 1 and Example 4, it can be seen that excellent advantage in the half life of luminance and the increase in drive voltage (ΔV) is obtained by using the compound of formula (1) as a light-emitting material and further advantage is obtained by using pyrrole compound as a host material.

It can be seen from the results in Table 1 that the luminescent devices of the invention are excellent in durability when the deuterium atom is substituted on the SP2 carbon atom of the compound having a 5-membered heterocyclic structure. In particular, it can be seen that conspicuous effect of the improvement in durability (prolonging the half time of luminance and suppressing the increase in drive voltage) can be obtained by the substitution of the hydrogen atom on the aryl group or the hydrogen atom on the SP2 carbon atom of the hetero aryl group with a deuterium atom.

The same effects can be obtained in the devices using other iridium compounds according to the invention.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2007-77414, filed Mar. 23, 2007, the entire disclosure of which is herein incorporated by reference.

What is claimed is:

1. An organic electroluminescent device comprising:
a pair of electrodes; and
at least one organic layer between the pair of electrodes, the at least one organic layer including a light-emitting layer,
wherein at least one of the at least one organic layers contains an iridium complex having a 5-membered heterocyclic structure consisting of a carbon atom and a nitrogen atom, and a deuterium atom on an SP2 carbon atom in the iridium complex.

2. The organic electroluminescent according to claim 1, wherein the 5-membered heterocyclic structure is a 5-membered heterocyclic structure including two nitrogen atoms.

3. The organic electroluminescent according to claim 1, wherein the iridium complex is a compound represented by formula (1): 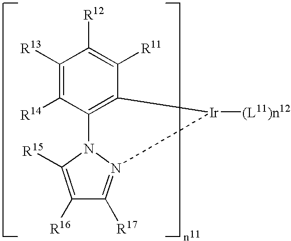
wherein R¹¹ to R¹⁷ each independently represents a hydrogen atom or a substituent, at least one of R¹¹ to R¹⁷ is a deuterium atom; L¹¹ represents a ligand and; n¹¹ represents an integer of from 1 to 3 and n¹² represents an integer of from 0 to 4, provided that n¹¹ and n¹² represent integers so that the coordination number of Ir is 6.

4. The organic electroluminescent device according to claim 1, wherein the iridium complex is a compound represented by formula (2): 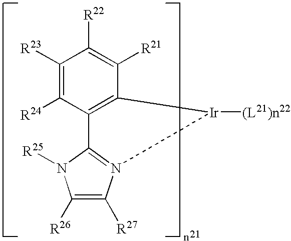
wherein R²¹ to R²⁷ each independently represents a hydrogen atom or a substituent, at least one of R²¹ to R²⁴, R²⁶ and R²⁷ is a deuterium atom; L²¹ represents a ligand and; n²¹ represents an integer of from 1 to 3 and n²² represents an integer of from 0 to 4, provided that n²¹ and n²² represent integers so that the coordination number of Ir is 6.

5. The organic electroluminescent device according to claim 1, wherein the iridium complex is a compound represented by formula (3): 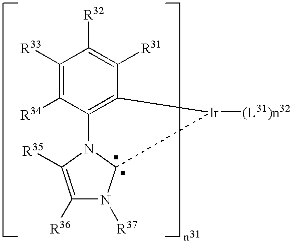
wherein R³¹ to R³⁷ each independently represents a hydrogen atom or a substituent, at least one of R³¹ to R³⁶ is a deuterium atom; L³¹ represents a ligand and; n³¹ represents an integer of from 1 to 3 and n³² represents an integer of from 0 to 4, provided that n³¹ and n³² represent integers so that the coordination number of Ir is 6.

6. The organic electroluminescent device according to claim 1, wherein the light-emitting layer contains pyrrole as a host material.

7. The organic electroluminescent device according to claim 1, satisfying a relationship: 0≦the number of hydrogen atoms on the SP2 carbon atom/the number of deuterium atoms on the SP2 carbon atom≦1.

8. The organic electroluminescent device according to claim 1, wherein the light-emitting layer contains a host material having a minimum triplet excitation state, and an energy level T₁ in the minimum triplet excitation state is from 60 to 90 kcal/mol.
